(19) United States
(12) Patent Application Publication
(10) Pub. No.: US 2010/0067954 A1
(43) Pub. Date: Mar. 18, 2010

(54) Line Head and Image Forming Apparatus

(75) Inventors: Nozomu INOUE, Matsumoto-shi (JP); Yoshio ARAI, Shiojiri-shi (JP); Kiyoshi TSUJINO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/553,023

(22) Filed: Sep. 2, 2009

(30) Foreign Application Priority Data
Sep. 18, 2008 (JP) 2008-239939

(51) Int. Cl. G03G 15/04

(52) U.S. Cl. 399/220

(57) ABSTRACT

A line head includes: a support member; a light emitting substrate unit having a first substrate supported by the support member and a plurality of light emitting elements arranged in a first direction of the first substrate; a circuit board unit having a second substrate and at least one interface circuit, which is provided to the second substrate, and to which at least one signal for driving the light emitting elements is input; and a flexible printed circuit board having a wiring pattern adapted to electrically connect the light emitting substrate unit and the circuit board unit to each other, wherein the flexible printed circuit board is disposed so as to be connected at an end of the second substrate in a second direction one of perpendicular and substantially perpendicular to the first direction, and is folded back from one end to the other end.

### BACKGROUND

1. Technical Field

The present invention relates to a line head and an image forming apparatus having the line head.

2. Related Art

Image forming apparatuses such as copy machines or printers using an electrophotographic method are each provided with an exposure section for executing an exposure treatment on an outer surface of a photoconductor to form an electrostatic latent image. As such an exposure section, a line head is put into practical use (see, e.g., JP-A-2005-74677 (Document 1))

For example, the line head according to the Document 1 is provided with a head substrate having a plurality of light emitting elements arranged in a main-scanning direction, a base plate supporting the head substrate, and a rod lens array disposed on a light exit side of the head substrate. In such a line head, light emitting diodes are used as the light emitting elements, and on the head substrate, there are mounted a driver IC for driving the light emitting diodes and so on besides the light emitting elements.

Further, in such a line head, the base plate is provided with a lengthy substrate mounting section for mounting the head substrate, and a pair of leg sections extending from both sides of the substrate mounting section in a longitudinal direction towards the side opposite to the head substrate. Such a base plate is formed by folding a plane metal plate, and can be manufactured at low cost.

However, in the line head according to the Document 1, since the driver IC or the like is mounted on the head substrate in addition to the light emitting elements, it is difficult to form the head substrate to have a width smaller than a certain value. In particular, in the case of using the light emitting diodes as the light emitting elements as in the case described in the Document 1, the light emitting elements are disposed so as to have a light axis perpendicular to the plate surface of the head substrate, and in general, it is necessary to mount bonding wires for connecting the light emitting elements and the driver IC to each other, a number of wiring patterns, a connector for connection with the outside, and so on on the head substrate, and therefore, the total width of the line head is limited by the width of the head substrate.

On the other hand, in the electrophotographic image forming apparatus, there are disposed devices such as a charger for charging the photoconductor at an initial potential, a developing section for developing the electrostatic latent image on the photoconductor as a toner image, a transfer section for transferring the toner image on the photoconductor to a transfer medium, a cleaner for removing the toner, which has not been transferred and remained on the photoconductor, and so on around the photoconductor besides the line head. Therefore, if the widths of these devices are large, the photoconductor needs to have a large diameter, which causes growth in size of the image forming apparatus. Further, increase in diameter of the photoconductor causes higher cost of the photoconductor. Since the photoconductor needs to be replaced every predetermined period, higher cost of the photoconductor is not preferable. Therefore, it is preferable to reduce the width of the line head as much as possible. Further, it is desired to provide a preferable assembling property to the line head.

### SUMMARY

The present invention has an advantage of providing a line head superior in assembling property, having a small width, and capable of making an image forming apparatus small-sized and low in price, and an advantage of providing a small-sized and low-price image forming apparatus.

The advantage described above is obtained by the following aspects of the invention.

A line head according to an aspect of the invention includes a support member, a light emitting substrate unit having a first substrate supported by the support member and a plurality of light emitting elements arranged in a first direction of the first substrate, a circuit board unit having a second substrate and at least one interface circuit, which is provided to the second substrate, and to which at least one signal for driving the light emitting elements is input, and a flexible printed circuit board having a wiring pattern adapted to electrically connect the light emitting substrate unit and the circuit board unit to each other, and the flexible printed circuit board is disposed so as to be connected at an end of the second substrate in a second direction one of perpendicular and substantially perpendicular to the first direction, and is folded back from one end to the other end.

In the line head according to the above aspect of the invention, it is preferable that the flexible printed circuit board is provided with a first folding-back section, and a second folding-back section is formed by folding back the flexible printed circuit board from the other end to the one end.

In the line head according to the above aspect of the invention, it is preferable that the second substrate is disposed so as to be perpendicular or substantially perpendicular to the first substrate.

In the line head according to the above aspect of the invention, it is preferable that the first substrate is disposed outside the support member.

In the line head according to the above aspect of the invention, it is preferable that the flexible printed circuit board is provided with at least one driver IC forming at least a part of a drive circuit adapted to drive the light emitting elements.

In the line head according to the above aspect of the invention, it is preferable that the driver IC is disposed so as to have contact with the support member.

According to another aspect of the invention, there is provided an image forming apparatus including a photoconductor adapted to accept light, and a line head disposed so as to be opposed to the photoconductor, wherein the line head includes a support member, a light emitting substrate unit having a first substrate supported by the support member and a plurality of light emitting elements arranged in a first direction of the first substrate, a circuit board unit having a second substrate and at least one interface circuit, which is provided to the second substrate, and to which at least one signal for driving the light emitting elements is input, and a flexible printed circuit board having a wiring pattern adapted to electrically connect the light emitting substrate unit and the circuit board unit to each other, and the flexible printed circuit board is disposed so as to be connected at an end of the second substrate in a second direction perpendicular or substantially perpendicular to the first direction, and is folded back from one end to the other end.

According to the line head of the above aspect of the invention having the configuration described above, since it becomes possible to mount at least a part of the drive circuit for driving the light emitting elements on the second substrate or the flexible printed circuit board instead of the first substrate, the number of elements and circuits mounted on the first substrate can be made the minimum necessary, and as a result, the width of the first substrate can be reduced.

Further, since the flexible printed circuit board is disposed so as to connect the ends of the first substrate and the second substrate in the width direction thereof, the line head can be prevented from becoming lengthy. Moreover, since the pair of legs of the support member are opposed to each other across the second substrate, the width of the line head can be reduced. In particular, by setting the flexible printed circuit board in the state of being folded from one end of the second substrate in the width direction thereof to the other end thereof, it becomes possible to prevent the flexible printed circuit board from hindering the installation of the line head, and to dispose (retract) the second substrate so that the pair of legs of the support member are opposed to each other via the second substrate while making the assembling property of the line head superior.

Thus, the line head according to the aspect of the invention can be made superior in assembling property, small in width, and capable of making the image forming apparatus small in size and low in price.

Further, according to the image forming apparatus of the aspect of the invention, by mounting the line head with a small width described above, it becomes possible to reduce the diameter of the photoconductor, and as a result, a small-sized and low-cost image forming apparatus can be obtained.

### BRIEF DESCRIPTION OF THE DRAWINGS

The invention will now be described with reference to the accompanying drawings, wherein like numbers reference like elements.

FIG. 1 is a schematic diagram showing an overall configuration of an image forming apparatus according to a first embodiment of the invention.

FIG. 2 is a perspective view showing a partial cross section of a line head provided to the image forming apparatus shown in FIG. 1.

FIG. 3 is a lateral cross-sectional view of the line head shown in FIG. 2.

FIG. 4 is a cross-sectional view showing a schematic configuration of a light emitting element provided to the line head shown in FIG. 2.

FIG. 5 is a diagram for explaining a relationship between a first substrate, a second substrate, and a wiring unit provided to the line head shown in FIG. 2,

FIG. 6 is a block diagram showing a configuration of a control system of the line head shown in FIG. 2.

FIG. 7 is a diagram for explaining a modified example of the control system shown in FIG. 6.

FIG. 8 is a lateral cross-sectional view of the line head according to a second embodiment of the invention.

FIG. 9 is a lateral cross-sectional view of the line head according to a third embodiment of the invention.

FIG. 10 is a lateral cross-sectional view of the line head according to a fourth embodiment of the invention.

FIG. 11 is a lateral cross-sectional view of the line head according to a fifth embodiment of the invention.

FIG. 12 is a lateral cross-sectional view of the line head according to a sixth embodiment of the invention.

### DESCRIPTION OF EXEMPLARY EMBODIMENTS

Hereinafter, the line head and the image forming apparatus according to the invention will be explained in detail based on some exemplary embodiments shown in accompanying drawings.

### First Embodiment

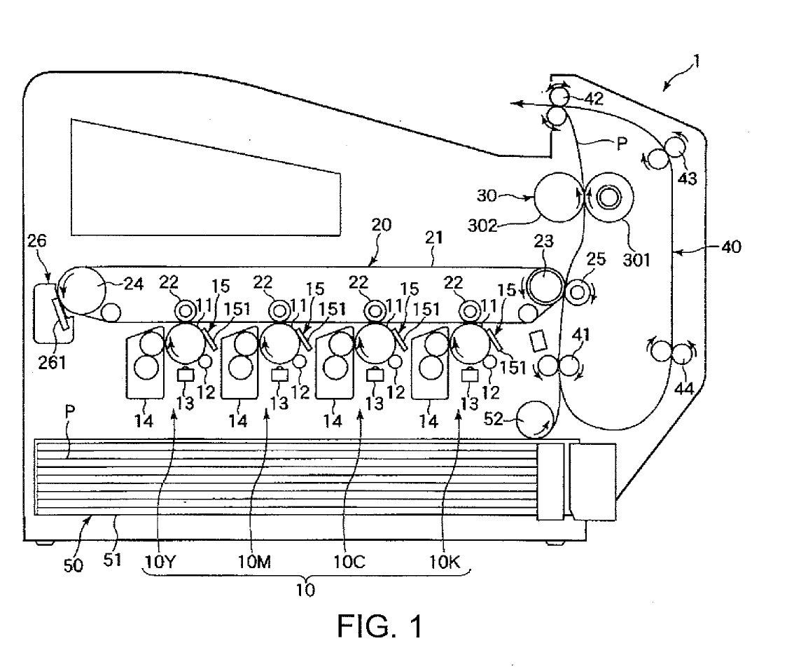

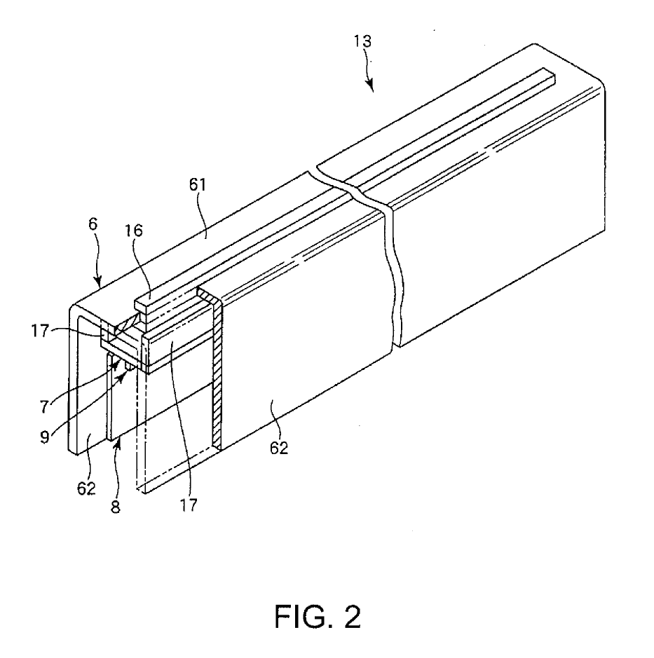

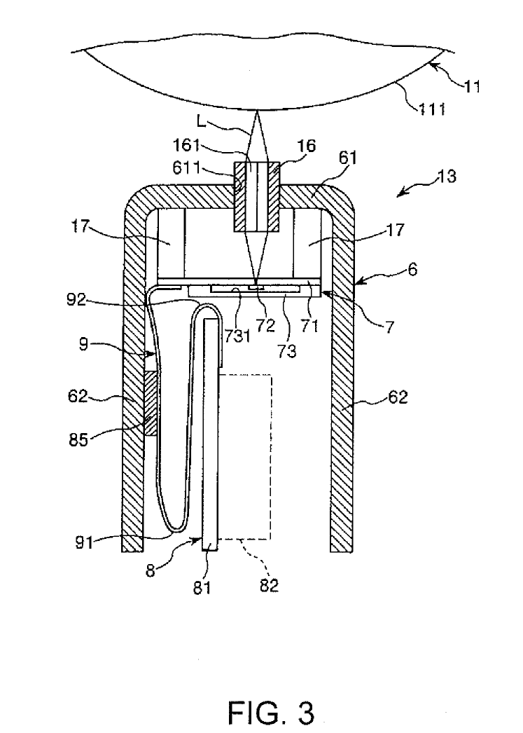

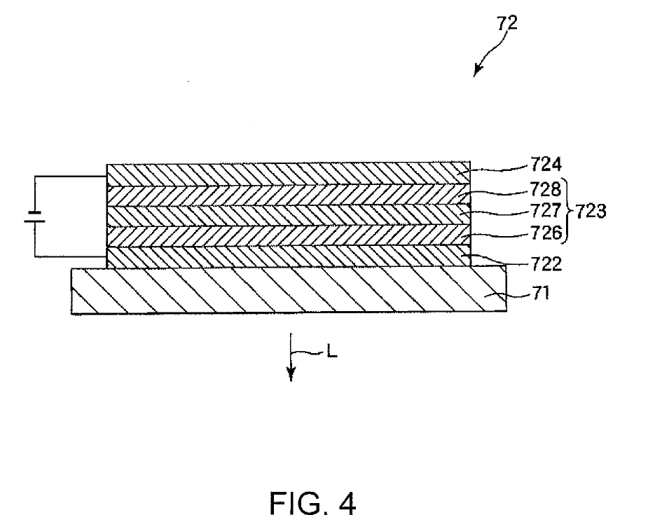

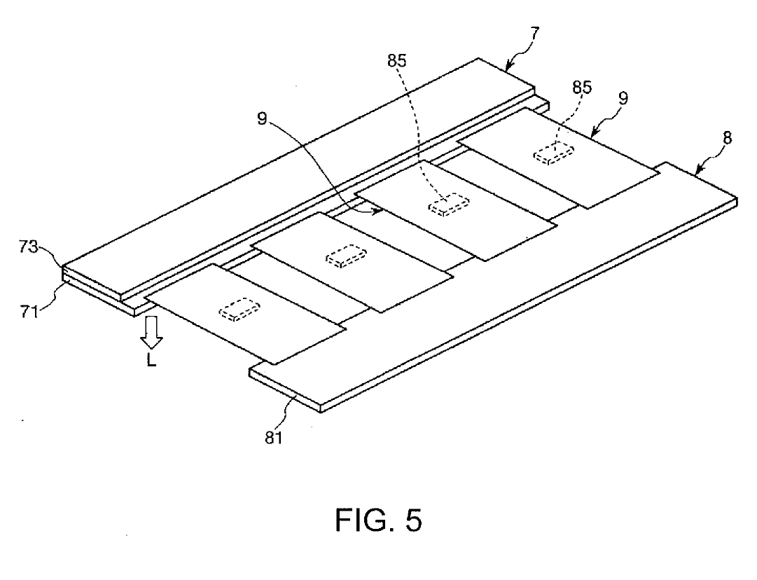

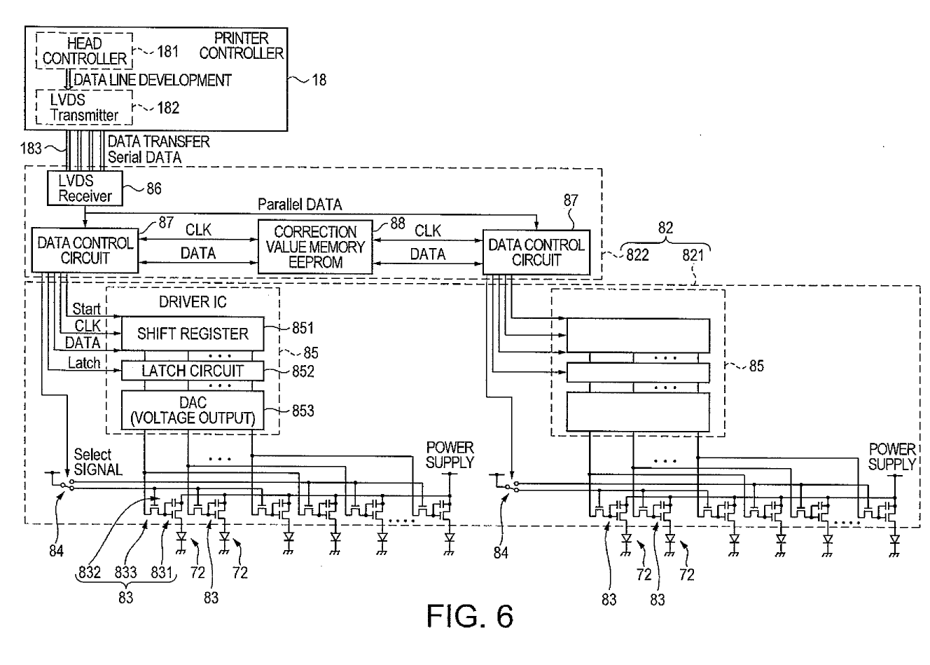

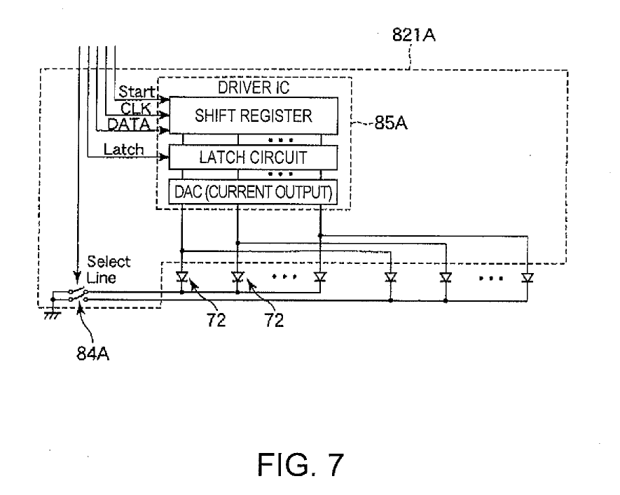

FIG. 1 is a schematic diagram showing an overall configuration of the image forming apparatus according to the first embodiment of the invention, FIG. 2 is a perspective view showing a partial cross-section of a line head provided to the image forming apparatus shown in FIG. 1, FIG. 3 is a lateral cross-sectional diagram of the line head shown in FIG. 2, FIG. 4 is a cross-sectional view showing a schematic configuration of a light emitting element provided to the line head shown in FIG. 2, FIG. 5 is a diagram for explaining a relationship between a first substrate, a second substrate, and a wiring unit provided to the line head shown in FIG. 2, FIG. 6 is a diagram showing a configuration of a control system of the line head shown in FIG. 2, and FIG. 7 is a diagram for explaining a modified example of the control system shown in FIG. 6. It should be noted that the upper side of FIGS. 1 through 3 is referred to as “upper side” and the lower side thereof is referred to as “lower side” in the following descriptions for the sake of convenience of explanations.

### Image Forming Apparatus

The image forming apparatus 1 shown in FIG. 1 is an electrophotographic printer, which records an image on a recording medium P through a series of image forming process including a charging process, an exposure process, a development process, a transfer process, and fixing process. In the present embodiment, the image forming device 1 is a color printer adopting a so-called tandem system.

As shown in FIG. 1, such an image forming apparatus 1 has an image forming unit 10 for the charging process, the exposure process, and the development process, a transfer unit 20 for the transfer process, a fixing unit 30 for the fixing process, a conveying mechanism 40 for conveying the recording medium P such as paper, and a paper feed unit 50 for feeding the recording medium P to the conveying mechanism 40.

The image forming unit 10 is provided with four image forming stations, namely an image forming station 10Y for forming a yellow toner image, an image forming station 10M for forming a magenta toner image, an image forming station 10C for forming a cyan toner image, and an image forming station 10K for forming a black toner image.

Each of the image forming stations 10Y, 10M, 10C, 10K has a photoconductor drum (photoconductor) 11 for carrying an electrostatic latent image, and in the periphery (an outer peripheral area) thereof, there are disposed a charging unit 12, a line head (an exposure unit) 13, a developing device 14, and a cleaning unit 15. Here, the image forming stations 10Y, 10M, 10C, 10K have substantially the same configurations as each other except the colors of the toners used therein, which are different from each other.

Each of the photoconductor drums 11 has a cylindrical overall shape and is arranged to be able to rotate around the axis line thereof in a direction of the arrow show in FIG. 1. Further, in the vicinity of the outer circumferential surface (a cylindrical surface) of the photoconductor drum 11, there is disposed a photoconductive layer (not shown). The outer circumferential surface of the photoconductor drum 11 has an acceptance surface 111 for accepting the light L (output light) from the line head 13 (see FIG. 3).

The charging unit 12 is for evenly charging the acceptance surface 111 of the photoconductor drum 11 using corona electrification or the like.

The line head 13 is for receiving image information from a host computer such as a personal computer not shown, and emitting light L toward the acceptance surface 111 of the photoconductor drum 11 in accordance therewith. When the light L is applied to the acceptance surface 111 of the photoconductor drum 11 charged evenly, a latent image (electrostatic latent image) corresponding to an irradiation pattern by the light L is formed on the acceptance surface 111. It should be noted that a configuration of the line head 13 will be explained later in detail.

The developing device 14 has a reservoir (not shown) for retaining the toner, and supplies the acceptance surface 111 of the photoconductor drum 11 with the toner from the reservoir, and applies the toner to the acceptance surface. When the toner is applied to the acceptance surface 111 on which the electrostatic latent image is formed, the latent image is visualized (developed) as a toner image.

The cleaning unit 15 has a cleaning blade 151 made of rubber having contact with the acceptance surface 111 of the photoconductor drum 11, and is arranged to scratch down and remove the toner, which remains on the photoconductor drum 11 after a primary transfer described later is executed, by the cleaning blade 151.

The transfer unit 20 is arranged to transfer the toner images of the respective colors, which are formed on the photoconductor drums 11 of the respective image forming stations 10Y, 10M, 10C, 10K described above, on the recording medium P in a lump.

In each of the image forming stations 10Y, 10M, 10C, 10K, electrification of the acceptance surface 111 of the photoconductor drum 11 by the charging unit 12, exposure of the acceptance surface 111 by the line head 13, supply of the toner to the acceptance surface 111 by the developing device 14, the primary transfer of the toner image to an intermediate transfer belt 21 by a primary transfer roller 22 described later, and cleaning of the acceptance surface 111 by the cleaning unit 15 are executed in sequence during the period in which the photoconductor drum 11 rotates one revolution.

The transfer unit 20 has the intermediate transfer belt 21 shaped like an endless belt, and the intermediate transfer belt 21 is stretched between a plurality (four in the configuration shown in FIG. 1) of primary transfer roller 22, a drive roller 23, and a driven roller 24, and rotationally driven in the direction of the arrows shown in FIG. 1 at substantially the same circumferential velocity as that of the photoconductor drum 11 in accordance with the rotation of the drive roller 23.

Each of the primary transfer rollers 22 is disposed so as to be opposed to the corresponding photoconductor drum 11 via the intermediate transfer belt 21, and arranged to transfer (primary-transfer) the monochromatic toner image on the photoconductor drum 11 to the intermediate transfer belt 21. To the primary transfer rollers 22, a primary transfer voltage (primary transfer bias) having the polarity reverse to the charging polarity of the toner is applied when executing the primary transfer.

On the intermediate transfer belt 21, there is carried at least one toner image with the corresponding color among yellow, magenta, cyan, and black. When forming a full-color image, for example, four toner images of respective colors, yellow, magenta, cyan, and black are transferred on the intermediate transfer belt 21 sequentially in an overlapping manner, thereby forming the full-color toner image as an intermediate image.

Further, the transfer unit 20 has a secondary transfer roller 25 disposed so as to be opposed to the drive roller 23 via the intermediate transfer belt 21, and a cleaning unit 26 disposed so as to be opposed to the driven roller 24 via the intermediate transfer belt 21.

The secondary transfer roller 25 is arranged to transfer (secondary-transfer) the toner image (an intermediate transfer image) such as a monochromatic image or a full-color image formed on the intermediate transfer belt 21 to the recording medium P such as paper, film, or cloth fed from the paper feed unit 50. When executing the secondary transfer process, the secondary transfer roller 25 is pressed against the intermediate transfer belt 21, and a secondary transfer voltage (secondary transfer bias) is applied to the secondary transfer roller 25. In such a secondary transfer process, the drive roller 23 also functions as a back-up roller of the secondary transfer roller 25.

The cleaning unit 26 has a cleaning blade 261 made of rubber having contact with a surface of the intermediate transfer belt 21, and is arranged to scratch down and remove the toner, which remains on the intermediate transfer belt 21 after the secondary transfer process is executed, by the cleaning blade 261.

The fixing unit 30 has a fixing roller 301 and a pressure roller 302 pressed against the fixing roller 301, and is configured so that the recording medium P passes between the fixing roller 301 and the pressure roller 302. Further, inside the fixing roller 301, there is incorporated a heater for heating the outer circumferential surface of the fixing roller 301. In the fixing unit 30 having such a configuration, the recording medium P to which the toner image is secondary-transferred is heated and pressurized while passing between the fixing roller 301 and the pressure roller 302 to fusion-bond the toner image to the recording medium P, thereby fixing the toner image as a permanent image.

The conveying mechanism 40 has a pair of resist rollers 41 for conveying the recording medium P to the secondary transfer section between the secondary transfer roller 25 and the intermediate transfer belt 21 described above with precise timing, and pairs of conveying rollers 42, 43, 44 for nipping and conveying the recording medium P on which the fixing treatment in the fixing unit 30 is executed.

When performing image formation only on one side of the recording medium P, such a conveying mechanism 40 nips and conveys the recording medium P, on one side of which the fixing treatment is executed by the fixing unit 30, with the pair of conveying rollers 42, and ejects it to the outside of the image forming apparatus 1. Further, in the case of performing image formation on both sides of the recording medium P, after once nipping the recording medium P, on one side of which the fixing treatment is executed by the fixing unit 30, by the pair of conveying rollers 42, the recording medium P is returned to the pair of resist rollers 41 while reversing the recording medium P by driving the pair of conveying rollers 42 in the reverse direction and at the same time driving the pairs of conveying rollers 43, 44, and then an image is formed on the other side of the recording medium P through substantially the same operation as described above.

The paper feed unit 50 is provided with a paper feed cassette 51 for housing the recording medium P unused, and a pick-up roller 52 for feeding the recording medium P one-by-one from the paper feed cassette 51 toward the pair of resist rollers 41.

### Line Head

Then, the line head 13 will now be explained.

The line head 13 is disposed so as to be opposed to the outer circumferential surface (i.e., the acceptance surface 111) of the photoconductor drum 11 (see FIGS. 1 and 3).

Further, as shown in FIG. 2, the line head 13 has a support member 6, a light emitting substrate unit 7, a circuit board unit 8, a wiring unit 9, a lens array 16 (an imaging optical system), and a spacer 17.

In such a line head 13, the light L emitted from the light emitting substrate unit 7 is transmitted through the spacer 17 and the lens array 16, and illuminates the acceptance surface 111 of the photoconductor drum 11.

Hereinafter, each section constituting the line head 13 will sequentially be explained in detail. It should be noted that in the following explanations, the longitudinal direction (a first direction) of a first substrate 71 of the light emitting substrate unit 7 is referred to as a “main-scanning direction,” and the width direction thereof is referred to as a “sub-scanning direction” for the sake of convenience of explanations.

The support member 6 has a lengthy shape (an elongated shape), and is disposed along the axis line direction (the main-scanning direction) of the photoconductor drum 11.

The support member 6 has a substrate mounting section 61 disposed along the plate surface of the first substrate 71 in the lateral cross-sectional view (a cross section perpendicular to the longitudinal direction of the first substrate 71 described later) shown in FIG. 3, and a pair of leg sections 62 extending from the both ends of the substrate mounting section 61 in the width direction (the sub-scanning direction) toward the first substrate 71. In other words, the lateral cross-sectional shape of the support member 6 is substantially U-shaped.

The substrate mounting section 61 has a lengthy plate shape, and on one surface thereof (the lower side in FIG. 3) there is mounted the first substrate 71 of the light emitting substrate unit 7 described later.

Further, the substrate mounting section 61 of the support member 6 is provided with an opening 611 penetrating therethrough in the thickness direction, and the lens array 16 is disposed so as to penetrate from the inside of the support member 6 to the outside thereof through the opening 611. In the present embodiment, the lens array 16 is fixed to the substrate mounting section 61 with an adhesive or the like.

The pair of leg sections 62 extend downward (i.e., toward the first substrate 71) from the both ends (i.e., the both sides in the longitudinal direction) in the width direction of the substrate mounting section 61. Thus, the light emitting substrate unit 7 is disposed between the pair of leg sections 62, namely inside the support member 6. In the manner as described above, the support member 6 is disposed so as to cover the light emitting substrate unit 7.

As described above, the support member 6 is formed so as to cover the light emitting substrate unit 7 while allowing emission of the light from each of light emitting elements 72 of the light emitting substrate unit 7 described later. Further, the support member 6 is formed of a folded metal plate. Such a support member 6 functions as an electromagnetic shield for preventing an undesired electromagnetic influence between the light emitting substrate unit 7 and the outside thereof.

Such a support member 6 is formed of a folded metal plate, and therefore, can be obtained at a low cost with relative ease. As a result, it is possible to prevent the undesired electromagnetic influence between the light emitting elements 72 and the outside thereof, thereby stably performing the exposure process with high accuracy while reducing the cost of the support member 6.

In particular, by forming the support member 6 so as to have the substantially U-shaped lateral cross section as described above, it is possible to cover the light emitting substrate unit 7 with the support member 6 with a relatively simple configuration. Further, it is also possible to make the rigidity of the support member 6 superior. Further, by supporting the first substrate 71 with the substrate mounting section 61, it is possible to stably support the first substrate 71, thereby performing the stable exposure process. Further, the support member 6 can also support (fix) a second substrate 81 described later.

Further, the support member 6 has a light blocking property. Therefore, the support member 6 also has a function of blocking the light failing to enter the lens array 16 described later from the light emitting elements 72. Thus, it is possible to perform the highly accurate exposure process at low cost without additionally providing a member for blocking the light.

A material for forming the support member 6 is not particularly limited, and various metal materials (in particular soft magnetic materials) can be used therefor, among which iron, stainless steel, and aluminum alloys are used preferably. It should be noted that the material for forming the support member 6 can be a material other than metal materials, such as a resin material. Further, the support member 6 can be formed by injection molding or press molding.

The light emitting substrate unit 7 is provided with the first substrate 71 having a lengthy shape, a plurality of light emitting elements 72 arranged on one side of the first substrate 71 along the longitudinal direction thereof, and a seal member 73 for covering the light emitting elements 72. The first substrate 71 is for supporting the light emitting elements 72, and is formed of a plate like member having a lengthy outer shape.

A material forming the first substrate 71 is not particularly limited, and for example, various types of glass materials and various types of resin materials can be used alone or in combination.

In the present embodiment, the first substrate 71 has an insulating property. Further, since each of the light emitting elements 72 is an element having a bottom emission structure as described later, the first substrate 71 is arranged to be substantially transparent (clear and colorless, clear and colored, or translucent). As such a material, for example, resin materials such as polyethylene terephthalate, polyethylene naphthalate, polypropylene, cycloolefin polymer, polyamide, polyethersulfone, polymethylmethacrylate, polycarbonate, or polyarylate, or glass materials such as quartz glass or soda glass can be cited, and these materials can be used alone or in combination.

Among these materials, it is preferable to use a glass material as the constituent material of the first substrate 71. In the case in which a glass substrate is use as the first substrate 71, organic electroluminescence elements (in particular the elements with the bottom emission structure described above) can be formed on the first substrate 71 as the light emitting elements 72 at low cost with relative ease. Further, it is possible to form not only the light emitting elements 72 but also TFT and so on on the first substrate 71 using device technologies in the display field. Further, since the glass substrate has a relatively high flatness, by using the glass substrate as the first substrate 71, it is possible to reduce the variation in distance between the light emitting element 72 and the lens array 16 to allow the lens array 16 to image the light L on the acceptance surface 111 of the photoconductor 11 with high accuracy.

Further, in the case in which the first substrate 71 is formed of various types of metal materials or glass materials, it is possible to efficiently release the heat caused by light emission of the light emitting elements 72 via the first substrate 71. Further, in the case of forming the first substrate 71 with various types of resin materials, a contribution to weight saving can be obtained.

It should be noted that in the case in which each of the light emitting elements 72 has a top emission structure, it is not required for the first substrate 71 to be substantially transparent, and it is possible to use various metal materials such as aluminum or stainless steel, or a ceramics material as the constituent material of the first substrate 71. On this occasion, the first substrate 71 is disposed so that the light emitting elements 72 face the lens array 16.

On one side (the lower surface in FIG. 3) of such a first substrate 71, there is bonded the plurality of light emitting elements 72 and the seal member 73.

The light emitting elements 72 are arranged on the first substrate 71 along the longitudinal direction (the main-scanning direction) thereof. Further, each of the light emitting elements 72 is disposed so that the light axis thereof is substantially perpendicular to the plate surface of the first substrate 71.

Each of the light emitting elements 72 is formed of an organic electroluminescence element (an organic EL element).

In further specific explanations, as shown in FIG. 4, each of the light emitting elements 72 is provided with an anode 722, an organic semiconductor layer 723 disposed on the anode 722, and a cathode 724 disposed on the organic semiconductor layer 723, and these layers are disposed on the first substrate 71.

Further, in the present embodiment, the organic semiconductor layer 723 has a layered structure composed of a hole transport layer 726, a light emitting layer 727, and an electron transport layer 728 stacked in this order from the anode 722 side.

In such a light emitting element 72, when a direct current voltage is applied between the anode 722 and the cathode 724, the electron transported via the electron transport layer 728 and the hole transported via the hole transport layer 726 are recombined with each other in the light emitting layer 727 in response thereto, excitons are generated due to the energy ejected upon the recombination, and the energy (fluorescence or phosphorescence) is then ejected as the light L when the excitons return to the ground state. Thus, the light emitting element 72 (the light emitting layer 727) emits light.

In the present embodiment, the light emitting element 72 is arranged to have the bottom emission structure in which the light L from the light emitting layer 727 is taken out to the anode 722 side and is used.

The anode 722 is an electrode for injecting holes to the organic semiconductor layer 723 (the hole transport layer 726 described later). Although not particularly limited thereto, as the constituent material of the anode 722, for example, indium tin oxide (ITO), SnO₂, Sb-doped SnO₂, an oxide of Al-doped ZnO, Au, Pt, Ag, Cu, or alloys including these metals can be cited, and at least one of these materials can be used.

The cathode 724 is an electrode for injecting electrons to the organic semiconductor layer 723 (the electron transport layer 728 described later). Further, the cathode 724 also has a function as a reflecting film for reflecting the light L, which leaks on the cathode 724 side, to the anode 722 side. Thus, it is possible to assure a larger amount of light L proceeding toward the lens array 16.

As the constituent material of the cathode 724, for example, Li, Mg, Ca, Sr, La, Ce, Er, Eu, Sc, Y, Yb, Ag, Cu, Al, Cs, Rb, or alloys including these metals can be cited, and at least one of these materials can be used.

Between the anode 722 and the cathode 724 there is disposed the organic semiconductor layer 723. As described above, the organic semiconductor layer 723 is provided with the hole transport layer 726, the light emitting layer 727, and the electron transport layer 728, and these layers are stacked in this order on the anode 722.

The hole transport layer 726 has a function of transporting holes, which are injected from the anode 722, to the light emitting layer 727.

Although any material having a hole transport capability can be adopted as the constituent material (a hole transport material) of the hole transport layer 726, the material is preferably a conjugated compound. The conjugated compounds can transport the holes extremely smoothly in the nature derived from the unique spread of the electron cloud, and therefore, are superior in hole transport capability.

As such a hole transport material, an aryl cycloalkane compound such as 1,1-bis(4-di-p-triaminophenyl)-cyclohexane, an arylamine compound such as 4,4′,4″-trimethyltriphenylamine, a phenylenediamine compound such as N,N,N′,N′-tetraphenyl-p-phenylenediamine, a triazole compound such as triazole, an imidazole compound such as imidazole, an oxadiazole compound such as 1,3,4-oxadiazole, an anthracene compound such as anthracene, a fluorenone compound such as fluorenone, an aniline compound such as polyaniline, and a phthalocyanine compound such as phthalocyanine can be cited, and these compounds can be used alone or in combination.

The electron transport layer 728 has a function of transporting electrons, which are injected from the cathode 724, to the light emitting layer 727.

As the constituent material (the electron transport material) of the electron transport layer 728, a benzene compound (a starburst compound) such as 1,3,5-tris[(3-phenyl-6-tri-fluoromethyl)-quinoxaline-2-yl]benzene (TPQ1), a naphthalene compound such as naphthalene, a phenanthrene compound such as phenanthrene, a chrysene compound such as chrysene, a perylene compound such as perylene, an anthracene compound such as anthracene, an oxadiazole compound such as oxadiazole, a triazole compound such as triazole can be cited, and these compounds can be used alone or in combination.

Further, as the light emitting layer 727, there can be adopted any layer formed of the constituent material to which holes can be input from the anode 722, and electrons can be input from the cathode 724, when applying the voltage, and which provides a field for the hole and the electron to recombine with each other.

As the constituent material (the light emitting material) of such a light emitting layer 727, there can be cited a benzene compound such as 1,3,5-tris[(3-phenyl-6-tri-fluoromethyl)-quinoxaline-2-yl]benzene (TPQ1), 1,3,5-tris[{3-(4-t-butylphenyl)-6-trisfluoromethyl}-quinoxaline-2-yl]benzene (TPQ2), a metal or metal-free phthalocyanine compound such as phthalocyanine, copper phthalocyanine (CuPc), or iron phthalocyanine, a small molecular compound such as tris(8-hydroxyquinolinolate)aluminum (Alq₃), fac-tris(2-phenylpyridine)iridium(Ir(ppy)₃), and a polymer compound such as an oxadiazole polymer, a triazole polymer, or a carbazole polymer, and the light L having a target emission color can be obtained by these materials alone or in combination.

In the present embodiment, each of the light emitting elements 72 is configured so as to emit red light. Here, as the light emitting layer 727 emitting the red light, there can be cited, for example, (4-dicyanomethylene)-2-methyl-6-(p-dimethylaminostyryl)-4H-pyran (DCM), and Nile red. It should be noted that the light emitting elements 72 are not limited to what is configured so as to emit the red light, but can be configured so as to emit monochromatic light with another color or white light. As described above, in the organic EL element, it is possible to arbitrarily set the light L emitted by the light emitting layer 727 to be the monochromatic light with an arbitrary color in accordance with the constituent material of the light emitting layer 727.

It should be noted that since the spectral sensitivity characteristic of the photoconductor drum used in the electrophotographic process is generally set so as to have a peak in a range from red to the near-infrared corresponding to the emission wavelength of the semiconductor laser, it is preferable to use the red light emitting material as described above.

In the case in which the light emitting elements 72 are each formed of such an organic electroluminescence element (an organic EL element), it is possible to set the distance (pitch) between the light emitting elements 72 to be relatively small. Thus, when recording an image on the recording medium P, the recording density to the recording medium P becomes relatively high. Therefore, the recording medium P carrying a clearer image can be obtained.

Further, in the case in which each of the light emitting elements 72 is formed of the organic EL element, it is possible to improve the layout density of the light emitting elements 72 in the longitudinal direction of the first substrate 71 while reducing the number of light emitting elements 72 in the width direction of the first substrate 71. Further, it is possible to form the TFT and wiring constituting a part of the drive circuit for driving the light emitting elements 72 on the first substrate 71 together with the light emitting elements 72 when forming the light emitting elements 72. As a result, it is possible to make the line head 13 lower in price while reducing the width of the first substrate 71.

It should be noted that it is also possible to dispose a light path adjustment member such as a reflector for preventing the light L from spreading on the outer circumference of each of the light emitting elements 72.

Further, the light emitting element 72 is not limited to the element with the bottom emission structure, but can be an element with a top emission structure using the light L, emitted from the light emitting layer 727, by taking out the light L to the cathode 724.

Further, the materials or the layer configuration of the organic EL element described above are for describing a representative example thereof, and the functions and advantages of the invention can also be obtained with other materials and layer configurations in substantially the same manner.

Further, the seal member 73 disposed on the one surface side of the first substrate 71 together with the plurality of light emitting elements 72 described above is provided with a recess 731, and is bonded to the first substrate 71 at the periphery of the recess 731 with an adhesive as shown in FIG. 3. Further, in the recess 731, there is housed the plurality of light emitting elements 72. Thus, the seal member 73 covers the plurality of light emitting elements 72.

The seal member 73 has a gas barrier property, and the seal member 73 and the first substrate 71 are airtightly bonded to each other. Thus, it becomes possible to shield the constituents of each of the light emitting elements 72 from the ambient gas containing moisture and oxygen, thereby preventing oxidization and deterioration of the constituents. Further, it is also possible to prevent foreign matters from adhering to each of the light emitting elements 72 and so on.

It is preferable to provide a drying agent, an oxygen absorber, or the drying agent and the oxygen absorber inside the recess 731 of the seal member 73. Thus, the oxidization and the deterioration of the constituents of each of the light emitting elements 72 can reliably be prevented.

As the drying agent, various compounds exerting a hygroscopic effect inside the recess 731 can be used without any particular limitations, and there can be cited, for example, sodium oxide (Na₂O), potassium oxide (K₂O), calcium oxide (CaO₄), barium oxide (BaO), magnesium oxide (MgO), lithium sulfate (Li₂SO₄), sodium sulfate (Na₂SO₄), calcium sulfate (CaSO₄), magnesium sulfate (MgSO₄), cobalt sulfate (CoSO₄), gallium sulfate (Ga₂(SO₄)₃), titanium sulfate (Ti(SO₄)₂), nickel sulfate (NiSO₄), calcium chloride (CaCl₂), magnesium chloride (MgCl₂), strontium chloride (SrCl₂), yttrium chloride (YCl₃), copper chloride (CuCl₂), cesium fluoride (CsF), tantalum fluoride (TaF₅), niobium fluoride (NbF₅), calcium bromide (CaBr₂), cerium bromide (CeBr₃), selenium bromide (SeBr₄), vanadium bromide (VBr₂), magnesium bromide (MgBr₂), barium iodide (BaI₂), magnesium iodide (MgI₂), barium perchlorate (Ba(ClO₄)₂), and magnesium perchlorate (Mg(ClO₄)₂).

Further, as the oxygen absorber, there can be cited activated carbon, silica gel, activated alumina, molecular sieve, magnesium oxide, iron oxide, titanium oxide, and so on.

Further, the seal member 73 has a flat plane on the opposite side to the recess 731. Thus, it is possible to easily and stably bond the first substrate 71 and the support member 6 to each other via the seal member 73.

Although not particularly limited, as the constituent material of the seal member 73, there can be cited a metal material such as stainless steel, aluminum, or alloys thereof, a glass material such as soda lime glass or silicate glass, and a resin material such as acrylic resin or styrene resin, and among these materials, the glass material is used preferably. By forming both of the seal member 73 and the first substrate 71 with the glass materials, it becomes possible to prevent the problems such as deformation or damage caused by the difference in linear expansion coefficient between these elements.

Meanwhile, the other surface (the upper surface in FIG. 3) of the first substrate 71 is optically joined to the substrate mounting section 61 of the support member 6 described above via the spacer 17.

The spacer 17 is for determining the distance between each of the light emitting elements 72 and the substrate mounting section 61 (the lens array 16) of the support member 6. It should be noted that the shape of the spacer 17 is not limited to the shape shown in the drawing, but an arbitrary shape capable of determining the distance between each of the light emitting elements 72 and the substrate mounting section 61 (the lens array 16) of the support member 6 can be adopted.

The lens array 16 is disposed on the side of the light emitting substrate unit 7 from which the light L is emitted. The lens array 16 has a number of gradient index rod lenses 161 arranged in two rows along the main-scanning direction in a closest-packing manner.

Each of the rod lenses 161 is installed so as to have the optical axis along the thickness direction of the first substrate 71 (i.e., parallel to the light axis direction of each of the light emitting elements 72). Further, each of the rod lenses 161 is formed, for example, of a resin material, a glass material, or the resin material and the glass material.

As described above, the circuit board unit 8 is connected to the light emitting substrate unit 7 via the wiring unit 9.

The circuit board unit 8 has a second substrate 81 and a circuit section 82 disposed on the second substrate 81.

The second substrate 81 is installed so that the plate surface thereof is disposed along the light axis of each of the light emitting elements 72 described above. In other words, the plate surface of the second substrate 81 is disposed so as to be perpendicular or substantially perpendicular to the plate surface of the first substrate 71 described above. In particular, in the present embodiment, the second substrate 81 is installed so as to fit inside the outline of the first substrate 71 in the plan view of the first substrate 71.

According to the installation of the second substrate 81 described above, the second substrate 81 can be installed so as not to affect the width of the line head 13 even if the width of the second substrate 81 becomes larger due to increase in the number of elements or circuits mounted on the second substrate 81. Therefore, it is possible to mount at least a part of the drive circuit or the like for driving the light emitting elements 72 described above on the second substrate 81 instead of mounting it on the first substrate 71. Thus, it becomes possible to set the number of elements or circuits mounted on the first substrate 71 to be the minimum necessary, and as a result, it becomes possible to reduce the width of the first substrate 71 described above. Therefore, it is possible to make the line head 13 small in width, thereby making the image forming apparatus 1 small in size and moderate in price.

Further, in the present embodiment, the second substrate 81 is installed in the vicinity of the leg section 62 on the side of the connecting section between the first substrate 71 and the wiring unit 9

As the constituent material of such a second substrate 81, substantially the same constituent materials as those of the first substrate 71 described above can be used, and a mixed material of the glass material and the resin material is preferably used. Specifically, the second substrate 81 is preferably a printed circuit board. Thus, the elements and the circuits necessary for driving the light emitting elements 72 can be mounted on the second substrate 81 with ease at low cost.

As shown in FIG. 6, the circuit section 82 is provided with a drive circuit 821 for driving the light emitting elements 72, and a control circuit 822 for controlling operations of the drive circuit 821.

The drive circuit 821 is for driving the light emitting elements 72.

In the present embodiment, the drive circuit 821 is provided with a plurality of constant current drive circuits 83 of a gate voltage holding type, a selection switch 84, and driver IC 85.

Each of the constant current drive circuits 83 has a constant current transistor 831, a voltage holding capacitor 832, and a selection transistor 833.

In each of the constant current drive circuits 83 described above, when the selection transistor 833 is switched ON, the constant current corresponding to the output voltage of the driver IC 85 described later flows into the light emitting element 72 through the constant current transistor 831, and the light emitting element 72 emits light. Further, since the output voltage of the driver IC 85 is held by the voltage holding capacitor 832, the current continues flowing through the light emitting element 72 even after the selection transistor 833 is switched OFF, and the emission by the light emitting element 72 is maintained.

The selection switch 84 is switched by a “select” signal from the control circuit 822, and selects the constant current drive circuits 83 every predetermined block. By switching the selection switch 84, it is possible to set the voltage applied to the light emitting elements 72 for each predetermined block.

The driver IC 85 is provided with a shift register 851, a latch circuit 852, and a D/A converter (DAC) 853.

In such a driver IC 85, a data signal (DATA) synchronized with a clock signal (CLK) is transmitted from the control circuit 822 to the shift register 851 using a “Start” pulse signal (Start) as a trigger. Meanwhile, the latch circuit 852 is provided with a “Latch” signal (Latch) transmitted from the control circuit 822, and the data signal is latched so that the data signal is aligned in the shift register 851 at predetermined timing. Then, the data signal (a digital signal) is transmitted to the DAC 853 in the state of being aligned at the predetermined timing, and the DAC 853 outputs a predetermined voltage signal (an analog signal) to the constant current drive circuit 83 (the selection transistor 833) described above.

It should be noted that although the drive circuit 821 described above is an active drive circuit, it is also possible to use a passive drive circuit 821A shown, for example, in FIG. 7 instead of the drive circuit 821. In the drive circuit 821A, constant current driver IC 85A is used, and the selection switch 84A is switched by the “Select” signal from the control circuit 822, and selects the light emitting elements 72 every predetermined block.

The drive circuit 821 as explained hereinabove is controlled by the control circuit 822.

The control circuit 822 is for controlling operations of the drive circuit 821. The control circuit 822 controls the operations of the drive circuit 821 based on signals from a printer controller 18 described later.

Such a control circuit 822 is provided with an interface circuit 86, a plurality (two in the present embodiment) of data control circuits 87, and a correction value memory 88.

The interface circuit 86 is for receiving signals from the printer controller 18 provided to a main body (the outside of the line head 13) of the image forming apparatus 1. In the present embodiment, the interface circuit 86 is formed of a receiving circuit using low voltage differential signaling (LVDS) as shown in FIG. 6, and receives the data developed on the data lines together with the timing clock from the printer controller 18, and then distributes it to the respective data control circuits 87.

The data control circuit 87 corrects the data from the interface circuit 86 based on the correction data in the correction value memory 88 so that the amount of emission of each of the light emitting elements 72 becomes optimum, and transmits the data thus corrected to the driver IC 85 (the shift register 851) described above together with the control signals.

The printer controller 18 has a function of transmitting the signals for controlling driving of each of the light emitting elements 72 to the control circuit 822. In the present embodiment, the printer controller 18 is provided with a head control section 181 for controlling driving of the line head 13, and a transmission circuit 182 for transmitting the signals from the head control section 181 to the interface circuit 86 described above. Further, the printer controller 18 also has a function of controlling each section of the image forming apparatus 1.

Driving of each of the light emitting elements 72 is controlled by such a control system (a circuit section 82). It should be noted that the configuration of the control system described above is an example, and is not limited thereto.

The circuit section 82 is disposed on the second substrate 81 described above, and therefore, installed so as to be covered by the support member 6 described above. In other words, the support member 6 is disposed so as to cover the circuit section 82. Thus, it becomes possible to prevent a negative electromagnetic effect such as incorporation of noise from the wiring between each of the light emitting elements 72 and the circuit section 82, thereby stably performing the highly accurate exposure process. Further, by disposing the circuit section 82 inside the support member 6, the length of the wiring between each of the light emitting elements 72 and the circuit section 82 can be reduced. Therefore, also from this viewpoint, incorporation of the noise from the wiring or the like between each of the light emitting elements 72 and the circuit section 82 can effectively be prevented.

It should be noted that it is also possible to form a part (e.g., the driver IC) of the circuit section 82 on the first substrate 71 or the wiring unit 9.

Such a circuit section 82 is electrically connected to each of the light emitting elements 72 via the wiring of the wiring unit 9.

The wiring unit 9 is provided with the wiring for electrically connecting the light emitting substrate unit 7 and the circuit board unit 8 to each other.

In the present embodiment, the wiring unit 9 is composed of a plurality of flexible printed circuit boards (FPC). Thus, it becomes possible to enhance the freedom of installing the second substrate 81 to the first substrate 71, and as a result, it becomes possible to install the second substrate 81 so that the plate surface thereof becomes perpendicular to the plate surface of the first substrate 71, as described above. It should be noted that the wiring unit 9 can be formed of a single flexible printed circuit board (FPC).

As shown in FIGS. 3 and 5, the wiring unit 9 (the flexible printed circuit board) is fixed to one ends of the first substrate 71 and the second substrate 81 in the width directions thereof, respectively. In other words, the wiring unit 9 (the flexible printed circuit board) is disposed so as to connect the ends of the first substrate 71 and the second substrate 81 in the width directions thereof, respectively. Thus, it becomes possible to reduce the size of the line head 13 in the longitudinal direction (to prevent the line head 13 from becoming lengthy). By using such a line head 13, it becomes possible to achieve downsizing (reduction of the size in the main-scanning direction) of the image forming apparatus 1.

In particular, the wiring unit 9 is provided with two folding-back sections 91, 92 in the state in which the second substrate 81 (the circuit board unit 8) is disposed inside the support member 6 as described above.

As shown in FIG. 3, the folding-back section 91 is formed by folding back the wiring unit 9, which extends downward from the one end of the first substrate 71, toward the upper side, and the folding-back section 92 is formed by folding back the wiring unit 9, which extends upward from the folding-back section 91, toward the lower side. Here, one of the two folding-back sections 91, 92 forms a first folding-back section, and the other thereof forms a second folding-back section.

Further, the folding-back section 91 is formed in the vicinity of the one end (the lower end in FIG. 3) of the second substrate 81, and the folding-back section 92 is formed in the vicinity of the other end (the upper end in FIG. 3) of the second substrate 81. As described above, the wiring unit 9 is folded back from the one end of the second substrate 81 to the other end thereof.

By thus setting the wiring unit 9 in the state of being folded back from the one end of the second substrate 81 in the width direction thereof to the other end thereof, it becomes possible to prevent the wiring unit 9 from hindering the installation of the line head 13, and to dispose the second substrate 81 inside the support member 6 while improving the assembling property of the line head 13.

In particular in the present embodiment, since the two folding-back sections 91, 92 described above are provided, it becomes possible to dispose the wiring unit 9 and the second substrate 81 inside the support member 6 even if the length of the wiring unit 9 is large. Further, since the length of the wiring unit 9 can be made larger, it becomes possible to drawing out the circuit board unit 8 (the second substrate 81) to the outside of the support member 6 while keeping the state of installing the light emitting substrate unit 7 (the first substrate 71) inside the support member 6. Therefore, the maintenance property of the line head 13 can be made superior. It should be noted that in the present embodiment, the length of the wiring unit 9 is set so that the wiring unit 9 fits the inside of the support member 6. It should be noted that the length of the wiring unit 9 can also be set in some cases so that a part of the wiring unit 9 runs off the support member 6 to the outside thereof.

Further, in the present embodiment, when developing the light emitting substrate unit 7, the circuit board unit 8, and the wiring unit 9 on a plane as shown in FIG. 5, the wiring unit 9 (the flexible printed circuit board) is bonded on the surfaces of the first substrate 71 and the second substrate 81 on the same side. Thus, the process of connecting the wiring unit 9 to the first substrate 71 and the second substrate 81 becomes simple and easy, and as a result, it becomes possible to make the line head 13 lower in price.

One end of the wiring patterns of such a wiring unit 9 is connected to the wiring patterns on the first substrate 71 with an anisotropic conductive adhesive (ACA) or the like. Similarly, the other end of the wiring patterns of the wiring unit 9 is connected to the wiring patterns on the second substrate 81 with an anisotropic conductive adhesive (ACA) or the like.

Further, in the present embodiment, the driver IC 85 forming a part of the drive circuit 821 described above is disposed on the wiring unit 9. A large number of wiring patterns from the light emitting substrate unit 7 can be put together on the wiring unit 9, and as a result, the number of terminals necessary for the connection between the wiring unit 9 and the circuit board unit 8 can be reduced.

Further, the driver IC 85 is disposed so as to have contact with the support member 6 (the inside surface of the support member 6). Thus, it becomes possible to release (radiate) the heat generated by the driver IC 85 to the support member 6. As a result, it becomes possible to prevent failure or malfunction of the driver IC 85, thereby improving the reliability of the line head 13.

According to the line head 13 as explained hereinabove, since the drive circuit 821 and so on for driving the light emitting elements 72 can be mounted on the second substrate 81 instead of mounting them on the first substrate 71, it becomes possible to set the number of elements and circuits mounted on the first substrate 71 to be the minimum necessary, and as a result, the width of the first substrate 71 can be made smaller.

Further, since the wiring unit 9 is disposed so as to connect the ends of the first substrate 71 and the second substrate 81 in the width direction thereof, the line head 13 can be prevented from becoming lengthy. Moreover, by disposing the second substrate 81 inside the support member 6, the width of the line head 13 can be made smaller. In particular, by setting the wiring unit 9 in the state of being folded back from the one end of the second substrate 81 in the width direction thereof to the other end thereof, it becomes possible to prevent the wiring unit 9 from hindering the installation of the line head 13, and to dispose the second substrate 81 inside the support member 6 while improving the assembling property of the line head 13. Thus, the line head 13 can be made superior in assembling property, small in width, capable of making the image forming apparatus 1 small in size and low in price.

### Second Embodiment

A second embodiment of the invention will hereinafter be described.

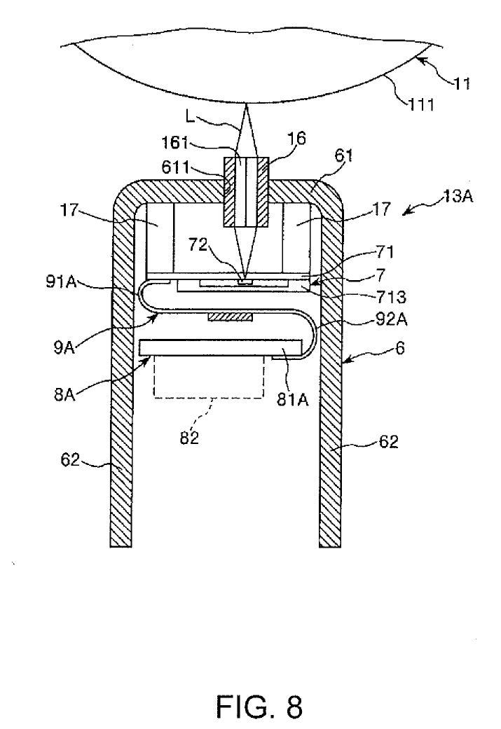

FIG. 8 is a lateral cross-sectional view of the line head according to the second embodiment of the invention.

Hereinafter, the line head according to the second embodiment will be described with a focus mainly on the differences from the first-embodiment described above, wherein the descriptions regarding the common matters will be omitted.

The line head 13A of the present embodiment is the same as the line head 13 of the first embodiment described above except differences in size and arrangement of the circuit board unit and the wiring unit.

In the line head 13A of the present embodiment, as shown in FIG. 8, the circuit board unit 8A is connected to the light emitting substrate unit 7 via the wiring unit 9A.

The circuit board unit 8A has the second substrate 81A disposed so as to be substantially parallel to the first substrate 71, and the circuit section 82 is disposed on the lower surface of the second substrate 81A.

Such a second substrate 81A has a width smaller than the internal width of the support member 6.

As shown in FIG. 8, the wiring unit 9 (the flexible printed circuit board) is fixed to one ends of the first substrate 71 and the second substrate 81A in the width directions thereof, respectively.

In particular, the wiring unit 9A is provided with two folding-back sections 91A, 92A in the state in which the second substrate 81A (the circuit board unit 8A) is disposed inside the support member 6.

The folding-back section 91A is formed by folding back the wiring unit 9A, which extends slightly leftward from the one end of the first substrate 71, toward the right side, and the folding-back section 92A is formed by folding back the wiring unit 9A, which extends rightward from the folding-back section 91A, toward the left side. Here, one of the two folding-back sections 91A, 92A forms a first folding-back section, and the other thereof forms a second folding-back section.

Further, the folding-back section 91A is formed in the vicinity of the one end (the left end in FIG. 8) of the second substrate 81A, and the folding-back section 92A is formed in the vicinity of the other end (the right end in FIG. 8) of the second substrate 81A. As described above, the wiring unit 9A is folded back from the one end of the second substrate 81A to the other end thereof.

Such a wiring unit 9A is set to have a smaller length so as to fit the inside of the support member 6.

According to the line head 13A as explained hereinabove, in addition to the same advantages as in the line head 13 of the first embodiment described above, there can be obtained an advantage that the size of the line head 13A in the light axis direction can be reduced.

### Third Embodiment

A third embodiment of the invention will hereinafter be explained.

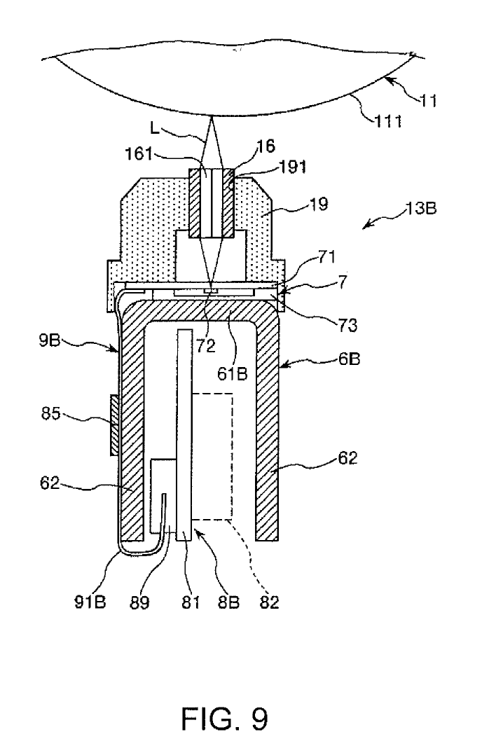

FIG. 9 is a lateral cross-sectional view of the line head according to the third embodiment of the invention.

Hereinafter, the line head according to the third embodiment will be described with a focus mainly on the differences from the first embodiment described above, wherein the descriptions regarding the common matters will be omitted.

The line head 13B of the present embodiment is the same as the line head 13 of the first embodiment described above except the installation positions of the light emitting substrate unit, the circuit board unit, and the wiring unit, the connection configuration between the circuit board unit and the wiring unit, and the fact that a light blocking member for blocking light between the lens array and the light emitting elements is provided.

As shown in FIG. 9, in the line head 13B, the light emitting substrate unit 7 is disposed outside the support member 6B.

The light emitting substrate unit 7 has contact with an upper surface of the substrate mounting section 61B of the support member 6B having a substantially U-shaped lateral cross section at the surface of the seal member 73 on the opposite side thereof to the first substrate 71, and is supported by the support member 6B. As described above, since the first substrate 71 is disposed outside the support member 6B, assembling becomes easier than in the case of disposing the first substrate 71 inside the support member 6B. As a result, the line head 13B becomes lower in price.

Further, since the first substrate 71 is disposed outside the support member 6B, the width of the support member 6B can be made smaller than the width of the first substrate 71. Therefore, the line head 13B can be made smaller in width.

On the upper surface of the first substrate 71 of the light emitting substrate unit 7, there is bonded and supported the light blocking member 19. The light blocking member 19 has a function of blocking the light failing to enter the lens array 16 described later from the light emitting elements 72.

Such a light blocking member 19 is formed so as to cover the upper surface of the first substrate 71. Further, the light blocking member 19 is provided with an opening 191 penetrating therethrough in the light axis direction of the light emitting elements 72, and the lens array 16 is disposed so as to penetrate from the inside of the light blocking member 19 to the outside thereof through the opening 191. In the present embodiment, the lens array 16 is fixed to the light blocking member 19 with an adhesive or the like.

The constituent material of the light blocking member 19 is not particularly limited providing the material has a light-blocking property, and resin materials, metal materials, and so on can be used therefor.

Further, the light blocking member 19 can be formed using injection molding, press molding, and so on.

Further, the circuit board unit 8B is provided with a connector 89 disposed on the second substrate 81. The wiring unit 9B and the circuit board unit 8B (the circuit section 82) are electrically connected to each other via the connector 89. By providing such a connector 89, it becomes possible to separately handle the light emitting substrate unit 7 and the circuit board unit 8B by separating them from each other, thereby improving the assembling property. As a result, the yield in the manufacturing process of the line head 13B can be improved, and further, the maintenance property of the line head 13B also becomes superior.

According to the line head 13B explained hereinabove, in addition to the same advantages as in the line head 13 of the first embodiment described above, an advantage of a smaller width, an advantage of achieving cost reduction, and an advantage of improving a maintenance property can also be obtained.

### Fourth Embodiment

A fourth embodiment of the invention will hereinafter be explained.

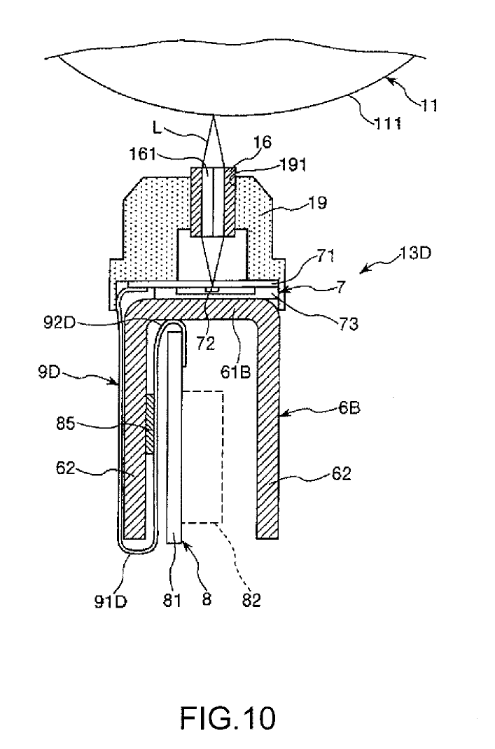

FIG. 10 is a diagram (a development view) for explaining a first substrate, a second substrate, and a wiring unit provided to the line head according to the fourth embodiment of the invention.

Hereinafter, the line head according to the fourth embodiment will be described with a focus mainly on the differences between the first embodiment described above and the fourth embodiment, wherein the descriptions regarding the common matters will be omitted.

The line head of the present embodiment is the same as the line head 13B of the third embodiment described above except differences in the arrangement of the wiring unit and connecting configuration between the circuit board unit and the wiring unit.

In the line head 13D of the present embodiment, the light emitting substrate unit 7 and the circuit board unit 8 are electrically connected to each other via the wiring unit 9D.

As shown in FIG. 10, the wiring unit 9D (the flexible printed circuit board) is fixed to one ends of the first substrate 71 and the second substrate 81 in the width directions thereof, respectively.

In particular, the wiring unit 9D is provided with two folding-back sections 91D, 92D in the state in which the second substrate 81 (the circuit board unit 8) is disposed inside the support member 6B.

The folding-back section 91D is formed by folding back the wiring unit 9D, which extends downward from the one end of the first substrate 71, toward the upper side, and the folding-back section 92D is formed by folding back the wiring unit 9D, which extends upward from the folding-back section 91D, toward the lower side. Here, one of the two folding-back sections 91D, 92D forms a first folding-back section, and the other thereof forms a second folding-back section.

Further, the folding-back section 91D is formed in the vicinity of the one end (the lower end in FIG. 10) of the second substrate 81, and the folding-back section 92D is formed in the vicinity of the other end (the upper end in FIG. 10) of the second substrate 81. As described above, the wiring unit 9D is folded back from the one end of the second substrate 81 to the other end thereof.

Further, the folding-back section 91D is folded back so as to hold one of the leg sections 62 of the support member 6B. Further, on the wiring unit 9D, there is disposed the driver IC 85 so as to have contact with the support member 6 (the inside surface of the support member 6).

According to the line head 13D of the fourth embodiment as explained hereinabove, in addition to the same advantages as in the line head 13 of the first embodiment described above, there can be obtained an advantage of the smaller width and an advantage of achieving further cost reduction.

### Fifth Embodiment

A fifth embodiment of the invention will hereinafter be explained.

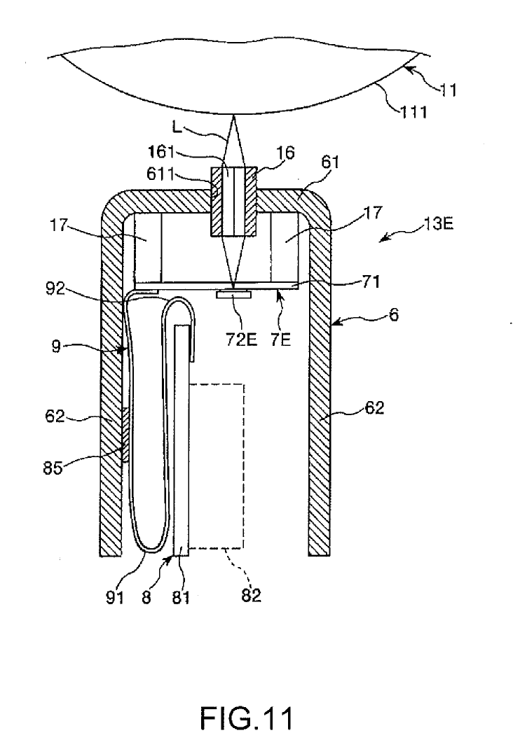

FIG. 11 is a lateral cross-sectional view of the line head according to the fifth embodiment of the invention.

Hereinafter, the line head according to the fifth embodiment will be described with a focus mainly on the differences from the first embodiment described above, wherein the descriptions regarding the common matters will be omitted.

The line head 13E of the present embodiment is the same as the line head 13 of the first embodiment described above except the fact that light emitting diodes (LED) are used as the light emitting elements, and the seal member is eliminated.

In the line head 13E of the present embodiment, a plurality of light emitting elements 72E is arranged on the lower surface of the first substrate 71 along the longitudinal direction thereof.

Each of the light emitting elements 72E is a light emitting diode.

According also to the line head 13E explained hereinabove, the same advantages as in the line head 13 of the first embodiment described above can be exerted.

### Sixth Embodiment

A sixth embodiment of the invention will hereinafter be explained.

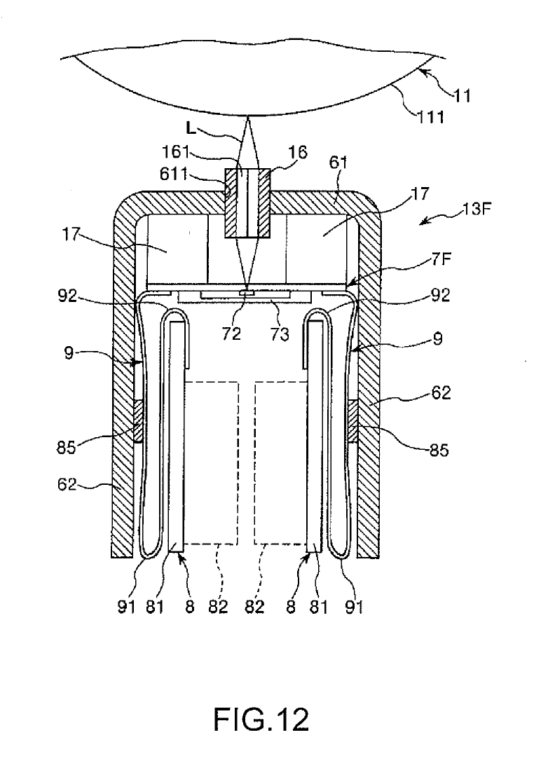

FIG. 12 is a lateral cross-sectional view of the line head according to the sixth embodiment of the invention.

Hereinafter, the line head according to the sixth embodiment will be described with a focus mainly on the differences from the first embodiment described above, wherein the descriptions regarding the common matters will be omitted.

The line head 13F of the present embodiment is the same as the line head 13 of the first embodiment described above except a difference in connecting configuration between the wiring unit, the light emitting substrate unit, and the circuit board unit.

In the line head 13F of the present embodiment, the circuit board units 8 are electrically connected to both ends of a single light emitting substrate unit 7F in the width direction via the wiring units 9, respectively.

According also to the line head 13F explained hereinabove, the same advantages as in the line head 13 of the first embodiment described above can be exerted.

Although hereinabove, the line head and the image forming apparatus according to the invention are explained along the embodiments shown in the drawings, the invention is not limited to the embodiments, and each of the constituents of the line head and the image forming apparatus can be replaced with what can exert substantially the same function and has an arbitrary configuration. Further, it is possible to add any constituents.

Further, the lens array is not limited to those having a plurality of lenses arranged in a 2×n matrix, but the lenses can be arranged, for example, in a 3×n matrix or in a 4×n matrix.

Further, a microlens array having a large number of microlenses arranged can also be used as the lens array.

Further, although in the embodiments described above what has the light emitting elements arranged in the 1×n matrix is explained for the sake convenience of explanations, the invention is not limited to this arrangement, but the light emitting elements can be arranged in a matrix such as a 2×n matrix or a 3×n matrix.

The entire disclosure of Japanese Patent Applications No. 2008-239939, filed on Aug. 19, 2008 is expressly incorporated by reference herein.

What is claimed is:

1. A line head comprising:
a support member;
a light emitting substrate unit having
a first substrate supported by the support member and
a plurality of light emitting elements arranged in a first direction of the first substrate;
a circuit board unit having
a second substrate and
at least one interface circuit, which is provided to the second substrate, and to which at least one signal for driving the light emitting elements is input; and
a flexible printed circuit board having a wiring pattern adapted to electrically connect the light emitting substrate unit and the circuit board unit to each other,
wherein the flexible printed circuit board is disposed so as to be connected at an end of the second substrate in a second direction one of perpendicular and substantially perpendicular to the first direction, and is folded back from one end to the other end,

2. The line head according to claim 1, wherein
the flexible printed circuit board is provided with a first folding-back section, and a second folding-back section is formed by folding back the flexible printed circuit board from the other end to the one end.

3. The line head according to claim 1, wherein
the second substrate is disposed so as to be one of perpendicular and substantially perpendicular to the first substrate.

4. The line head according to claim 1, wherein
the first substrate is disposed outside the support member.

5. The line head according to claim 1, wherein
the flexible printed circuit board is provided with at least one driver IC forming at least a part of a drive circuit adapted to drive the light emitting elements.

6. The line head according to claim 5, wherein
the driver IC is disposed so as to have contact with the support member.

7. An image forming apparatus comprising:
a photoconductor adapted to accept light; and
a line head disposed so as to be opposed to the photoconductor,
wherein the line head includes
a support member,
a light emitting substrate unit having
a first substrate supported by the support member and
a plurality of light emitting elements arranged in a first direction of the first substrate,
a circuit board unit having
a second substrate and
at least one interface circuit, which is provided to the second substrate, and to which at least one signal for driving the light emitting elements is input, and
a flexible printed circuit board having a wiring pattern adapted to electrically connect the light emitting substrate unit and the circuit board unit to each other, and
the flexible printed circuit board is disposed so as to be connected at an end of the second substrate in a second direction one of perpendicular and substantially perpendicular to the first direction, and is folded back from one end to the other end.
